(19) United States
(12) Patent Application Publication
(10) Pub. No.: US 2023/0243789 A1
(43) Pub. Date: Aug. 3, 2023

(54) ANALYSIS DEVICE AND ANALYSIS METHOD

(71) Applicant: SHIMADZU CORPORATION, Kyoto (JP)

(72) Inventor: Shinji KANAZAWA, Kyoto (JP)

(21) Appl. No.: 18/096,857

(22) Filed: Jan. 13, 2023

(30) Foreign Application Priority Data
Jan. 28, 2022 (JP) 2022-011415

(51) Int. Cl. G01N 30/86; G01N 30/88

(52) U.S. Cl. CPC G01N 30/8631; G01N 30/8693; G01N 30/88

(57) ABSTRACT

A certainty factor of peak picking can be calculated when the peak picking is performed using semantic segmentation technology. An analysis device divides a target waveform into a plurality of partial waveforms, determines a peak waveform that becomes a peak portion among the plurality of divided partial waveforms using a trained model, and calculates the certainty factor of a determination result of the peak waveform using data output from the trained model when the peak portion of the target waveform is determined using the trained model.

### BACKGROUND OF THE INVENTION

### Field of the Invention

The present disclosure relates to an analysis device and an analysis method for analyzing waveforms of a chromatogram and a spectrum.

### Description of the Background Art

Conventionally, a chromatograph has been used to identify or quantify components contained in a sample. In the chromatograph, components in the sample are separated by a column, and components flowing out from the column are sequentially detected. Thereafter, the chromatogram in which a horizontal axis represents time while a vertical axis represents detection intensity is produced.

In order to determine a peak height and area from the chromatogram, peak start and end points rising from a baseline of the chromatogram are required to be identified. An operation of identifying the peak start and end points of the chromatogram is called peak picking. The peak height and area are determined by identifying the peak start and end points. A concentration of a compound corresponding to the peak and the like can be calculated from the peak height and area.

In recent years, an attempt to automate the peak picking using deep learning have been made. A technique using an object detection technology and a technique using a semantic segmentation technology are known as a peak picking technique using the deep learning.

WO 2020/225864 discloses a technique for displaying a certainty factor of a peak picking result using a single shot multibox detector (SSD) by formulating a peak picking problem as object detection in an image recognition field. The SSD collectively outputs the peak picking result and the certainty factor for the peak picking result. On the other hand, “Kanazawa S and 10 others, Fake metabolomics chromatogram generation for facilitating deep learning of peak-picking neural networks. J Biosci Bioeng. 2021 February; 131 (2): 207-212. doi: 10,1016/j.jbiosc, 2020.09. 013.Epub 2020 Oct. 10, PMID: 33051155.” discloses a technique for executing the peak picking using U-Net by formulating the peak picking as a semantic segmentation problem.

### SUMMARY OF THE INVENTION

However, there is no technique for calculating the certainty factor in the peak picking using semantic segmentation technology. For this reason, in the conventional peak picking technique using the semantic segmentation technology, the peak picking result is output, but the certainty factor of the output result is not output.

An object of the present disclosure is to enable the calculation of the certainty factor of the peak picking when the peak picking is performed using the semantic segmentation technology.

An analysis device according to one aspect of the present disclosure is an analysis device that analyzes a target waveform that is a chromatogram or a spectrum, the analysis device including: a processor; and a memory that stores a trained model produced by machine learning using a plurality of sets including a plurality of partial waveforms produced by dividing a reference waveform in which a position of a peak portion is known, wherein the processor divides the target waveform into a plurality of partial waveforms, determines a peak portion of the target waveform using the trained model, classifies the target waveform into a peak region where the peak portion continues and a non-peak region other than the peak region based on a determination result of the peak portion of the target waveform, and calculates a certainty factor of a determination result of the peak portion using data output from the trained model when the peak portion of the target waveform is determined using the trained model.

An analysis method according to one aspect of the present disclosure is an analysis method for analyzing a target waveform that is a chromatogram or a spectrum, the analysis method including: producing a trained model that specifies a peak portion included in an input waveform by machine learning using a plurality of sets of a plurality of partial waveforms produced by dividing a reference waveform in which a position of the peak portion is known; dividing the target waveform into a plurality of partial waveforms; determining the peak portion of the target waveform using the trained model; classifying the target waveform into a peak region where the peak portion continues and a non-peak region other than the peak region based on a determination result of the peak portion of the target waveform; and calculating a certainty factor of a determination result using data output from the trained model when the peak portion of the target waveform is determined using the trained model.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating an overall configuration of an analysis device.

FIG. 2 is a view illustrating an example of the chromatogram.

FIG. 3 is a block diagram illustrating a procedure for producing a trained model.

FIG. 4 is a flowchart illustrating the procedure for producing the trained model.

FIG. 5 is a flowchart illustrating a procedure for determining chromatogram data using the trained model.

FIG. 6 is a view illustrating an example of a determination result of the trained model,

FIG. 7 is a view illustrating an example of a graph on which labeling processing is performed based on the determination result.

FIG. 8 is a view illustrating an example of an image displaying a certainty factor together with the determination result.

FIG. 9 is a view illustrating an example of an image that receives an operation for correcting the determination result.

FIG. 10 is a view illustrating a relationship between the certainty factor of a peak and a correct answer rate.

FIG. 11 is a view illustrating first to seventh modifications of a technique for calculating the certainty factor of the peak.

FIG. 12 is a view illustrating the seventh modification.

### DESCRIPTION OF THE PREFERRED EMBODIMENT

With reference to the drawings, embodiments of the present disclosure will be described in detail below. In the drawings, the same or corresponding portion is denoted by the same reference numeral, and the description thereof will not be repeated.

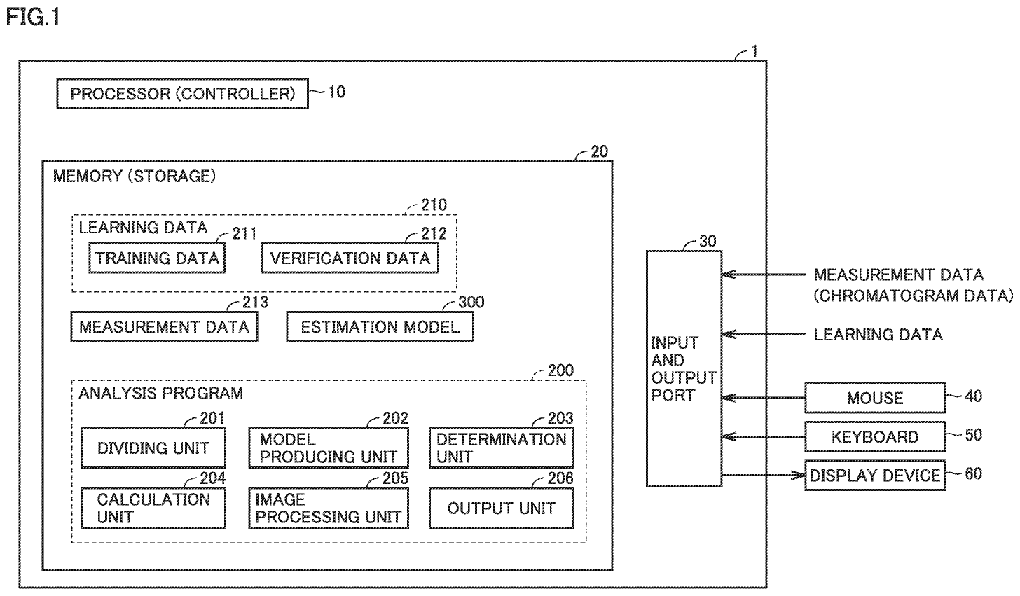

FIG. 1 is a block diagram illustrating an entire configuration of an analysis device 1. Analysis device 1 includes a processor 10 that functions as a controller, a memory 20 that functions as a storage, and an input and output port 30. A mouse 40, a keyboard 50, and a display device 60 are connected to input and output port 30. A mass spectrometer or the like may be connected to input and output port 30. One or a plurality of terminal devices may be connected to input and output port 30 through the Internet, an internal network, or the like.

For example, analysis device 1 is configured using a personal computer as a base. Analysis device 1 may be configured by a server that can be accessed from one or a plurality of terminal devices through a network such as the Internet.

Measurement data (chromatogram data) to be analyzed and learning data used for machine learning are input to input and output port 30. The measurement data to be analyzed may be input through a mass spectrometer connected to input and output port 30. A liquid chromatograph mass spectrometry system can be configured by a mass spectrometer, a liquid chromatograph connected to the mass spectrometer, and analysis device 1.

Memory 20 stores at least learning data 210 input to input and output port 30, measurement data 213 input to input and output port 30), an estimation model 300 used for machine learning, and an analysis program 200 executing analysis processing and machine learning processing.

Learning data 210 is classified into training data 211 and verification data 212. Training data 211 and verification data 212 are waveform data of the chromatogram obtained by measuring a sample containing various components using a chromatograph mass spectrometer. For example, the chromatogram is a total ion chromatogram representing a temporal change in total intensity of ions of all detected mass-to-charge ratios obtained by MS scanning measurement of components separated by a liquid chromatograph using a mass spectrometer. The chromatogram may be a mass chromatogram that is measured by SIM measurement or MRM measurement to represent a temporal change in intensity of ions of a specific mass-to-charge ratio.

Training data 211 and verification data 212 include position data of a previously-specified peak by the peak picking. The waveform data is previously normalized so as to be within a predetermined range (for example, ±1.0) of an intensity value. The accuracy of the trained model can be enhanced by unifying a plurality of chromatograms having different intensity scales by the normalization to a common intensity scale. The chromatogram obtained by measuring the actual sample is used as training data 211 and verification data 212 in this case, and a chromatogram produced by simulation may be used.

The waveform of the chromatogram is divided into a predetermined number of partial waveforms in a time-axis direction. For example, the predetermined number is 512 or 1024, and is set such that a width (a length in the time-axis direction) of each partial waveform is at least smaller than a peak width. For example, the predetermined number is determined based on magnitude of the peak width and the number of data points required for forming one peak.

Each partial waveform data is associated with information (characteristic information) about a characteristic of the partial waveform. Characteristic information associated with the partial waveform includes at least information indicating whether the partial waveform belongs to a peak region or a non-peak region.

A dividing unit 201, a model producing unit 202, a determination unit 203, a calculation unit 204, an image processing unit 205, and an output unit 206 are configured by analysis program 200.

Dividing unit 201 divides the waveform of the chromatogram into a predetermined number of partial waveforms. Using learning data 210, model producing unit 202 advances the machine learning of estimation model 300 to produce trained estimation model 300. Determination unit 203 performs the peak picking of the chromatogram using trained estimation model 300, Hereinafter, sometimes trained estimation model 300 is referred to as a “trained model”.

Calculation unit 204 calculates the certainty factor of the determination result of determination unit 203. Image processing unit 205 produces image data including the determination result and the certainty factor. Output unit 206 outputs a display signal including the image data from input and output port 30 to display device 60. Analysis device 1 may include display device 60.

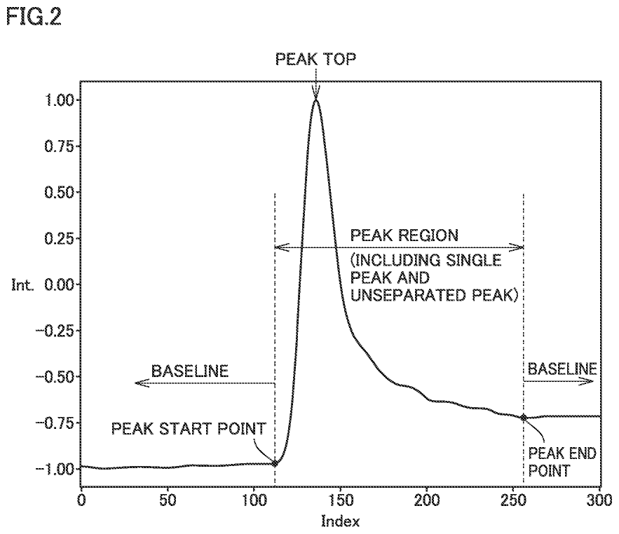

FIG. 2 is a view illustrating an example of the chromatogram. Here, the name of each portion specified from the chromatogram will be briefly described. The chromatogram can be classified into a portion of the baseline and the peak region, A rising portion from the baseline is referred to as the peak start point and the peak end point. The region between the peak start point and the peak end point is referred to as the peak region. In the peak region, a portion where detection intensity is very strong (the strongest portion) is referred to as a peak top.

The peak region includes a single peak as illustrated in FIG. 2. When an unseparated peak appears in the waveform of the chromatograph, the peak region includes a single peak and an unseparated peak. For example, a portion, in which two mountain-shaped waveforms having the peak top as the top are connected and the detection intensity of the portion corresponding to the valley between the two mountain-shaped waveforms does not fall to the intensity corresponding to the baseline, is referred to as the unseparated peak.

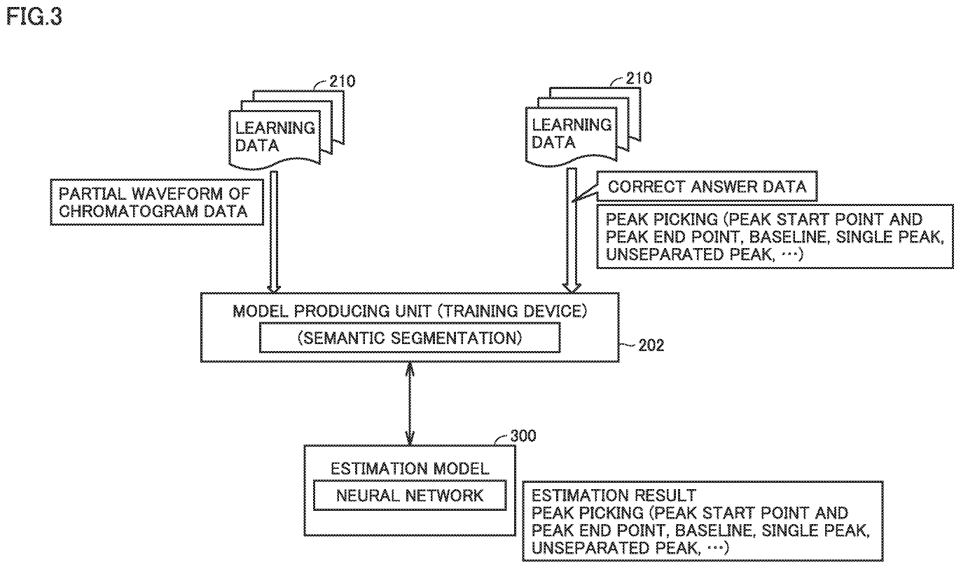

With reference to a flowchart, a procedure for producing the trained model will be described below. FIG. 3 is a block diagram illustrating a procedure for producing a trained model. As illustrated in FIG. 3, model producing unit 202 of analysis device 1 functions as a training device. Model producing unit 202 trains estimation model 300 based on input learning data 210. Estimation model 300 performs deep learning using a neural network. Estimation model 300 includes parameters such as weighting coefficients used for calculation by the neural network.

For example, a supervised learning algorithm is used to train estimation model 300. Model producing unit 202 trains estimation model 300 by the supervised learning using learning data 210.

A technique of semantic segmentation is used to train estimation model 300. The semantic segmentation is generally used to analyze an image configured by two-dimensionally-distributed pixel data. In the embodiment, the semantic segmentation is applied to the analysis of the waveform of the chromatogram configured of data arranged one-dimensionally along a time axis. For example, U-Net, SeGNet, or PSPNet can be used as a training model capable of executing the semantic segmentation. In the embodiment, U-Net is used.

The partial waveform of the chromatogram and correct answer data corresponding to the partial waveform of the chromatogram are input to model producing unit 202. For example, the correct answer data is a peak picking result that is already specified. The peak picking result may include the peak top.

Model producing unit 202 determines a result of the peak picking based on input learning data 210 and estimation model 300, and trains estimation model 300 based on the determination result and the correct answer data. Specifically, model producing unit 202 trains estimation model 300 by adjusting the parameter in estimation model 300 such that the result obtained by estimation model 300 approaches the correct answer data.

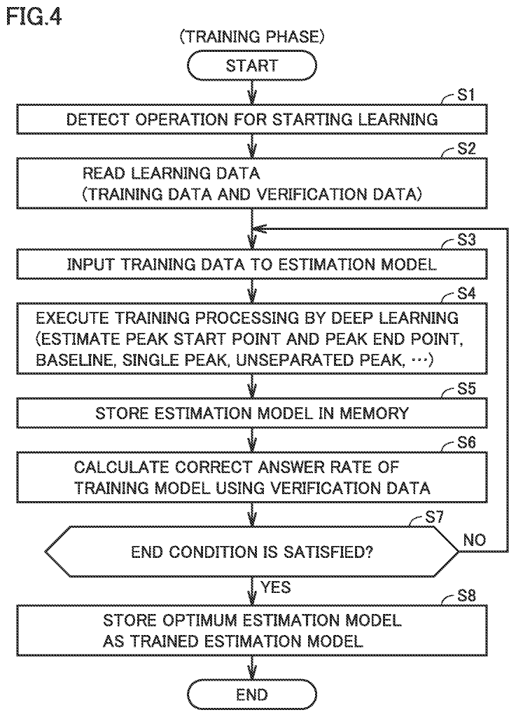

FIG. 4 is a flowchart illustrating the procedure for producing the trained model. Processor 10 of analysis device 1 executes a part of analysis program 200, thereby implementing the processing of this flowchart.

First, processor 10 detects an operation for starting training of estimation model 300 (step S1). For example, when the user performs the operation for starting the training of estimation model 300 using mouse 40 and keyboard 50, the operation is detected in step S1.

Subsequently, processor 10 reads learning data 210 (training data 211 and verification data 212) from memory 20 (step S2). Subsequently, processor 10 inputs training data 211 to estimation model 300 (step S3). Subsequently, in estimation model 300, the training processing by the deep learning is executed (step S4). In the U-Net used for the training of estimation model 300 in the embodiment, the weighting of the neural network is adjusted such that correct characteristic information can be obtained from the partial waveform.

More specifically, the parameter of the estimation model 300 is adjusted based. on the partial waveform of training data 211 and the characteristic information associated with the partial waveform. In the processing for adjusting the parameter, processing for estimating the single peak, the unseparated peak, the peak start point, the peak end point, the baseline, and the like and processing for comparing the estimation result with correct answer data are executed.

Subsequently, processor 10 stores estimation model 300 produced according to the result of the training processing of step S4 in memory 20 (step S5). Subsequently, processor 10 checks a correct answer rate of the characteristic information added by analyzing the partial waveform of verification data 212 using estimation model 300 (step S6).

Subsequently, processor 10 determines whether a predetermined end condition is satisfied (step S7). For example, when the number of times of the training processing repeatedly performed using training data 211 reaches a predetermined number, processor 10 determines that the end condition is satisfied. When the end condition is not satisfied, processor 10 repeats the pieces of processing in steps S3 to S6 until the end condition is satisfied.

When the end condition is satisfied, processor 10 selects an appropriate one from the plurality of estimation models 300 stored in memory 20, and stores selected estimation model 300 in memory 20 as the trained model (step S8).

Thus, processor 10 ends the series of processing in FIG. 4. For example, the trained model is selected based on that the correct answer rate for verification data 212 is the highest, that over-learning is not generated, or the like. Here, an example in which estimation model 300 is stored in memory 20 for each learning cycle has been described. However, the same estimation model 300 may be repeatedly updated until the number of times of training reaches a predetermined number of times, and estimation model 300 may be stored in memory 20 when the number of times of training reaches the predetermined number of times.

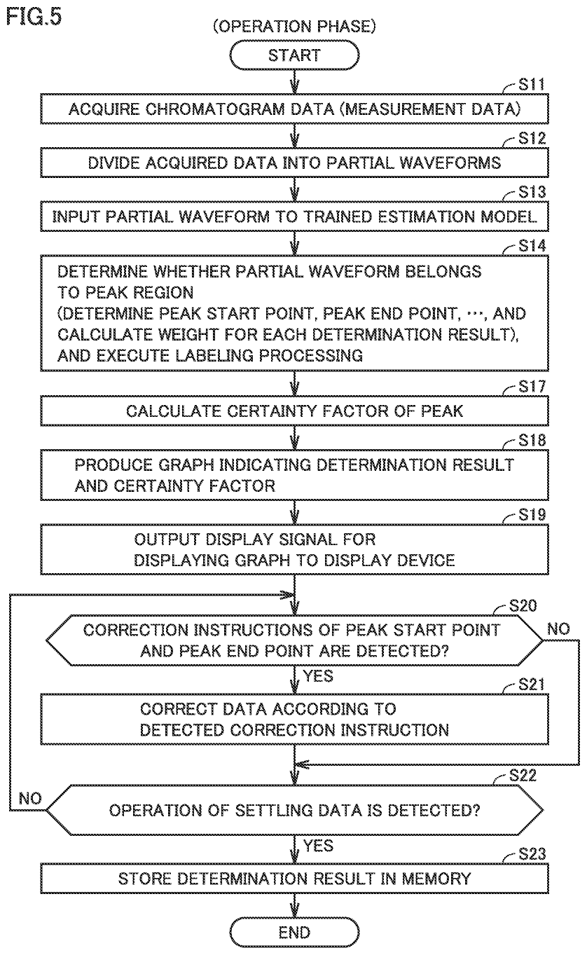

With reference to a flowchart, a procedure for analyzing the waveform of an unanalyzed chromatogram will be described below. FIG. 5 is a flowchart illustrating a procedure for determining the chromatogram data using the trained model (trained estimation model 300). Processor 10 of analysis device 1 executes a part of analysis program 200, thereby implementing the processing of this flowchart.

First, processor 10 acquires the chromatogram data (measurement data) (step S11). The chromatogram data is input to analysis device 1 through a measuring instrument such as a mass spectrometer connected to input and output port 30 or a terminal device connected to input and output port 30.

Subsequently, processor 10 divides the waveform of the acquired chromatogram into a predetermined number of partial waveforms (step S12). The number of divisions of the chromatogram waveform may be the same as or different from the number of divisions of training data 211 and verification data 212.

However, the number of divisions is determined according to the length of the waveform (the length of the execution time of the chromatograph mass spectrometry) such that the width (the length in the time-axis direction) of each partial waveform is at least smaller than the width of the peak predicted to be included in the chromatogram. For example, it is conceivable to set the number of divisions to 512 or 1024.

Subsequently, processor 10 inputs the partial waveform to trained estimation model 300 (trained model) (step S13). Subsequently, whether the partial waveform belongs to the peak region is determined by the trained model, and labeling processing is executed (step S14). More specifically, the peak start point and the peak end point, the baseline, the single peak, the unseparated peak, the peak top, and the like are determined from the partial waveform. In addition, the weight of each determination result is calculated. In addition, in step S14, the characteristic information (information about whether the partial waveform belongs to the peak region) is added to each partial waveform.

Subsequently, processor 10 calculates the certainty factor of the peak (step S17). The certainty factor of the peak is calculated by an average value of a weight corresponding to the peak start point determined by the trained model and a weight corresponding to the peak end point determined by the trained model.

Subsequently, processor 10 produces a graph indicating the determination result and the certainty factor (step S18). In the embodiment, a plurality of types of graphs are produced by processor 10. Processor 10 outputs a display signal for displaying the produced graph to display device 60 (step S19). Thus, the determination result and the certainty factor are displayed on display device 60. For example, in a screen of display device 60, the peak start point, the peak end point, and the certainty factor are displayed on the waveform of the chromatogram.

Subsequently, processor 10 determines whether correction instructions of the peak start point and the peak end point are detected (step S20). In the embodiment, the user can perform the operation for correcting the peak start point and the peak end point on the screen of display device 60. When the correction instruction is not detected, processor 10 advances the processing to step S22.

When the user performs the operation for correcting the peak start point and the peak end point using mouse 40 and keyboard 50, processor 10 corrects the data on the screen according to the correction instructions (step S21). In this manner, processor 10 receives the correction instructions of the user and corrects the peak start point and the peak end point.

After correcting the data, processor 10 determines whether an operation settling the data is detected (step S22). When the operation settling the data is not detected, processor 10 returns the control to step S20. When the operation settling the data is detected, processor 10 stores the determination result (the corrected determination result when the data is corrected) in memory 20 (step S23), and ends the processing based on this flowchart.

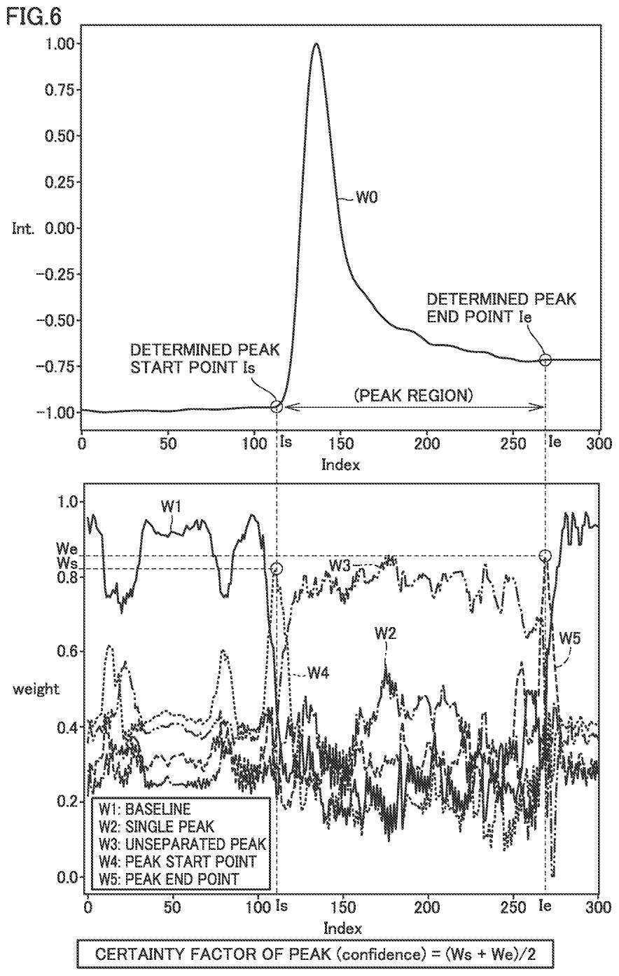

FIG. 6 is a view illustrating an example of a determination result of the trained model. An upper graph in FIG. 6 illustrates a waveform W0 of the input chromatogram. A lower graph in FIG. 6 represents the determination result of the trained model for the input chromatogram. The horizontal axis (index) of both graphs corresponds to the time axis. The vertical axis of the upper graph in FIG. 6 represents the intensity. The vertical axis of the lower graph in FIG. 6 indicates the weight output by the trained model. The weight is normalized to a range of 0 to 1.

Waveforms W1 to W5 indicated as the determination results of the trained model correspond to the baseline, the single peak, the unseparated peak, the peak start point, and the peak end point, respectively. By comparing waveform W0 of the chromatogram with waveforms W1 to W5, for example, it can be seen that the weight corresponding to the peak start point becomes the highest at the position of an index Is in waveform W0 of the chromatogram. Similarly, it can be seen that the weight corresponding to the peak end point becomes the highest at the position of an index le in waveform W0 of the chromatogram. In this case, for example, analysis device 1 determines the position of index Is in waveform WO of the chromatogram as the peak start point, and determines the position of index Ie as the peak end point.

Here, examples of the determination target include the peak start point, the peak end point, the single peak, the unseparated peak, and the baseline, but another element such as the peak top can be added to the determination target.

As illustrated in FIG. 6, processor 10 specifies the certainty factor of the peak by calculating an average value of a weight Ws corresponding to a peak start point Is determined by the trained model and a weight We corresponding to a peak end point Ie determined by the trained model.

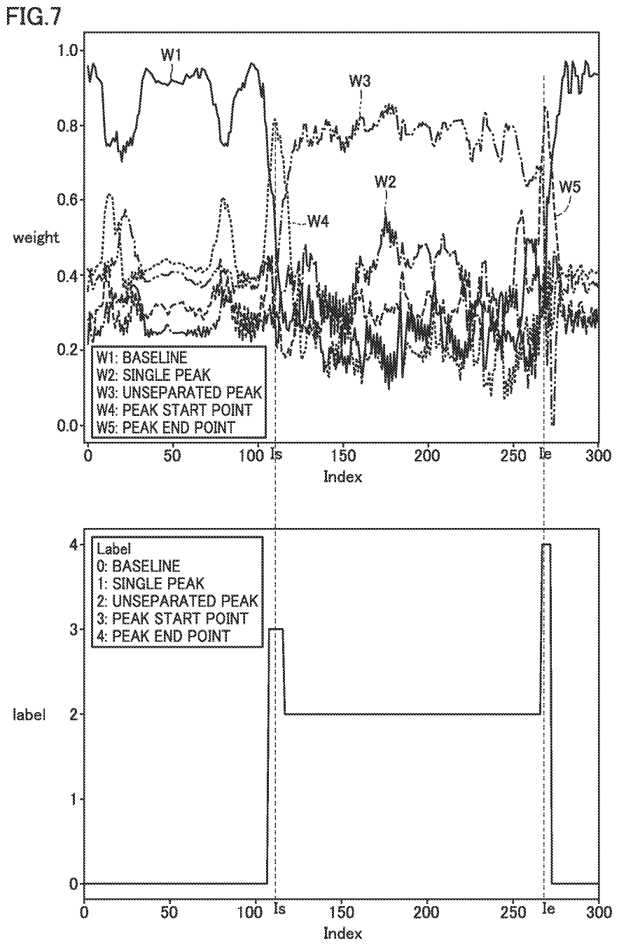

FIG. 7 is a view illustrating an example of a graph on which labeling processing is performed based on the determination result. The upper graph in FIG. 7 is the same as the lower graph in FIG. 6. The lower graph in FIG. 7 is a graph in which waveform W0 (see FIG. 6) of the input chromatogram is labeled based on waveforms W1 to W5. Labels 0 to 4 correspond to the baseline, the single peak, the unseparated peak, the peak start point, and the peak end point, respectively.

For example, the labeling processing is performed in the following procedure, That is, among waveforms W1 to W5, the waveform having the largest weight at the position of a certain index Ix is selected, and the value of index Ix is labeled by the selected waveform. The labeling processing ends by repeating the same processing while changing x from the initial value to the final value of the index. For example, FIG. 7 illustrates a graph in which an interval from indexes 0 to Is labeled (label=0) as the baseline.

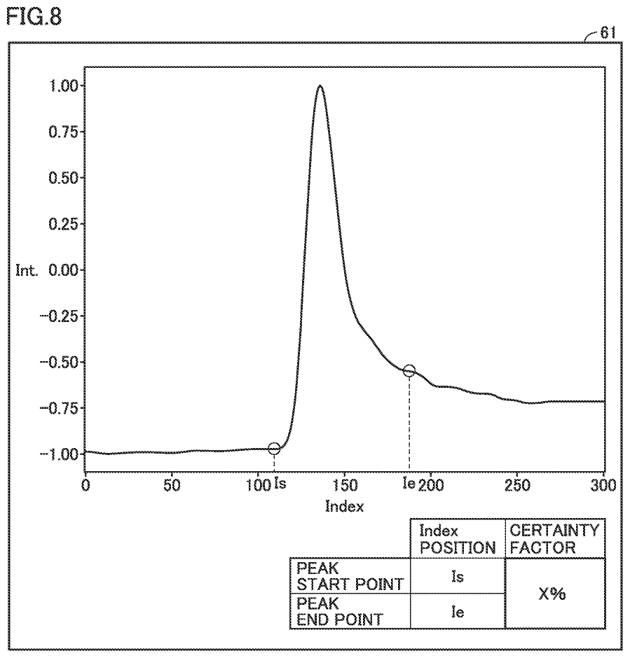

FIG. 8 is a view illustrating an example of an image 61 displaying a certainty factor together with the determination result. Image 61 is displayed by display device 60. In image 61, peak start point Is and peak end point Ie corresponding to the determination result are illustrated together with the waveform of the chromatogram to be measured. Furthermore, image 61 displays the certainty factor with respect to determined peak start point Is and peak end point Ie. The user can recognize the certainty of the determination result by viewing image 61.

In addition to image 61, processor 10 can selectively display the image including two graphs of an aspect in FIG. 6, the image including two graphs of an aspect in FIG. 7, and the image in which three graphs included in FIGS. 6 and 7 are arranged in the vertical direction on display device 60. The certainty factor is also displayed on both images in the mode in FIG. 8. The user can input an instruction indicating which image is to be displayed to analysis device 1 using mouse 40 and keyboard 50.

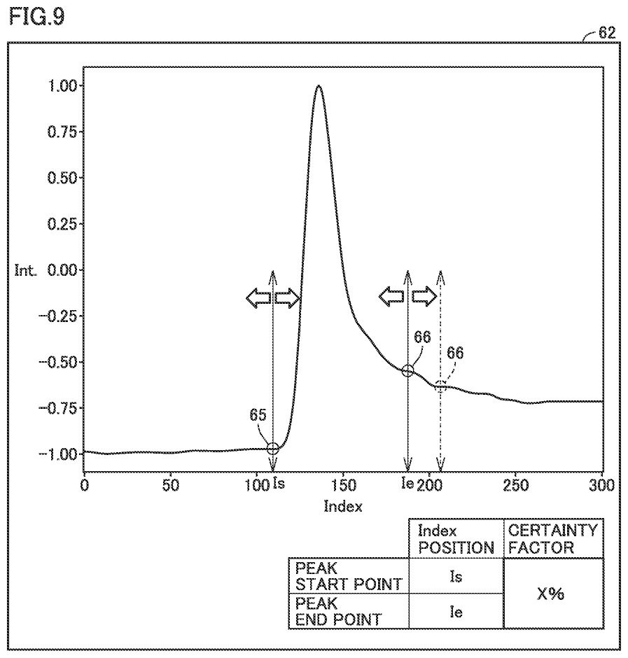

FIG. 9 is a view illustrating an example of an image 62 that receives an operation for correcting the determination result. Image 62 is displayed by display device 60. In image 62, icons 65, 66 correcting the positions of peak start point Is and peak end point Ie are displayed in addition to the content in FIG. 8.

Icon 65 corresponds to peak start point Is. When the user operates icon 65 using mouse 40 and keyboard 50, the position of peak start point Is changes. When the user operates icon 66 using mouse 40 and keyboard 50, the position of peak end point Ie changes. An index position and the certainty factor displayed below the graph also change interlocked with the change of the positions of peak start point Is and peak end point Ie.

The user performs an operation for fixing the data after the correction of the positions of peak start point Is and peak end point Ie to appropriate positions. When an operation for determining the data is detected by processor 10, the corrected result is stored in memory 20.

Here, an example in which icons 65, 66 are displayed based on image 61 in FIG. 8 is illustrated. However, icons 65, 66 correcting the determination result may be displayed for the image including the two graphs of the aspect in FIG. 6, the image including the two graphs of the aspect in FIG. 7, and the image in which the three graphs included in FIGS. 6 and 7 are arranged in the vertical direction.

As described above, in the embodiment, the determination result and the certainty factor of the trained model are displayed on display device 60. Thus, the user can visually discriminate the probable peak information and the peak information having lower reliability than the probable peak information. As a result, the instruction of visual check or correction by the user is further simplified, and a burden on the user in such the work can be reduced. In addition, when analyzing the waveform in which a large number of peaks are observed, the number of peaks to be checked by the user is reduced, so that an error in checking work, overlooking, or the like can be prevented.

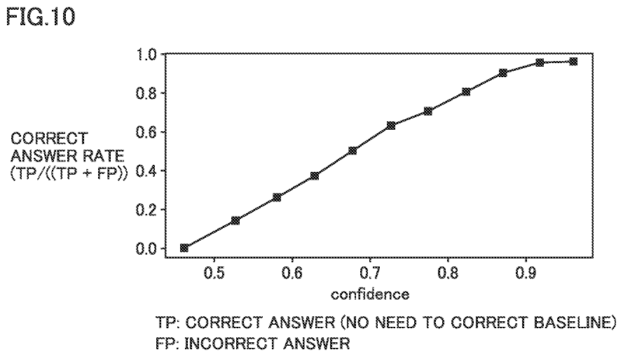

An example, in which the trained model is produced using actual chromatogram data and the waveform analysis of the chromatogram is performed, will be described. In producing the trained model, 30 sets of chromatograms of primary metabolites were prepared. One set included 475 chromatograms. Each prepared chromatogram was manually peak-picked. Thereafter, the waveform of the chromatogram was classified into five classes of the baseline, the peak start point, the peak end point, the single peak, and the unseparated peak, and each was labeled. Thus, the learning data was created. Cross-validation evaluation was performed using the prepared learning data. The cross validation evaluation, using one set out of the 30 sets as verification data, was performed 30 times. The weight of the peak start point output from the trained model and the weight of the peak start point output from the trained model were added together and divided by 2 to calculate the weighted average value, and this was taken as the certainty factor of the peak. Then, the relationship between the certainty factor and the correct answer rate was verified. FIG. 10 illustrates a verification result.

FIG. 10 is a view illustrating a relationship between the certainty factor of a peak and a correct answer rate. In FIG. 10, TP indicates the number of correct answers, and FP indicates the number of incorrect answers. As illustrated in FIG. 10, the higher the certainty factor (confidence), the higher the correct answer rate. From this, it can be seen that the certainty factor calculation method disclosed in the embodiment is effective.

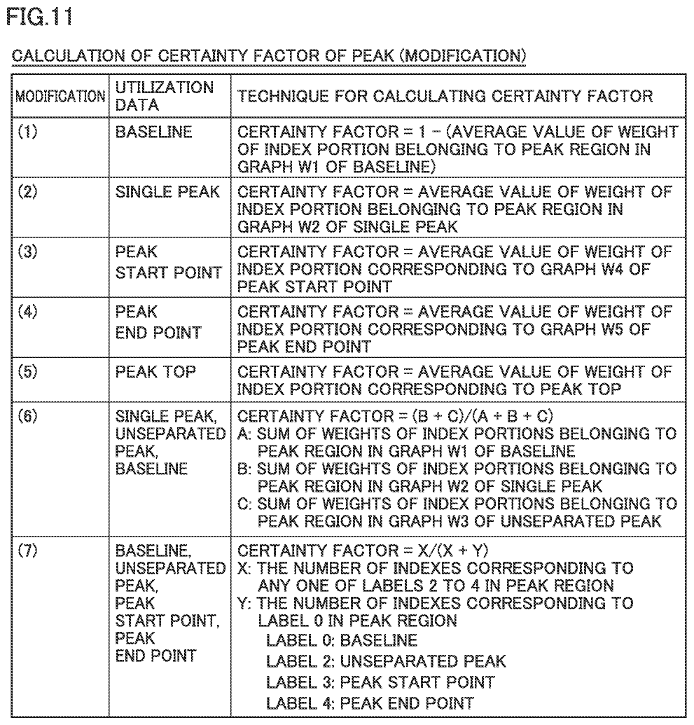

With reference to FIG. 11, a modification regarding the technique for calculating the certainty factor of the peak will be described below. FIG. 11 is a view illustrating first to seventh modifications of the technique for calculating the certainty factor of the peak. Waveforms W1 to W5 used in the following description of the modification are illustrated in FIGS. 6 and 7.

As illustrated in FIG. 11, the certainty factor of the peak can be calculated using any one of the baseline (first modification), the single peak (second modification), the peak start point (third modification), the peak end point (fourth modification), and the peak top (fifth modification) alone.

The first modification is an example of calculating the certainty factor of the peak using the baseline. As illustrated in FIG. 11, the certainty factor can be calculated by “1—(average value of weights of index portions belonging to peak region in waveform W1 of baseline)”. Here, for example, the index portion belonging to the peak region means a range of indexes Is to Ie in FIG. 6.

The second modification is an example of calculating the certainty factor of the peak using the single peak. As illustrated in FIG. 11, the certainty factor can be calculated by “average value of weights of index portions belonging to peak region in waveform W2 of single peak”.

The third modification is an example of calculating the certainty factor of the peak using the peak start point. As illustrated in FIG. 11, the certainty factor can be calculated by “average value of weights of index portions corresponding to waveform W4 of peak start point”. For example, in FIG. 6, the certainty factor is derived by specifying the weight corresponding to waveform W4 for each index in the range from the initial value of the index to the terminal value to calculate the average value of all the specified weights.

The fourth modification is an example of calculating the certainty factor of the peak using the peak end point. As illustrated in FIG. 11, the certainty factor can be calculated by “average value of weights of index portions corresponding to waveform W5 of peak end point”.

The fifth modification is an example of calculating the certainty factor of the peak using the peak top. As illustrated in FIG. 11, the certainty factor can be calculated by “average value of weights of index portions corresponding to peak top”.

The sixth modification is an example in which the certainty factor of the peak is calculated by combining the single peak, the unseparated peak, and the baseline. As illustrated in FIG. 11, the certainty factor is calculated by “(B+C)/(A+B+C)”. At this point, A, B, and C are as follows.

A: Sum of weights of index portions belonging to peak region in waveform W1 of baseline

B: Sum of weights of index portions belonging to peak region in waveform W2 of single peak

C: Sum of weights of index portions belonging to peak region in waveform W3 of unseparated peak

The seventh modification is an example in which the certainty factor of the peak is calculated by combining the baseline, the unseparated peak, the peak start point, and the peak end point. As illustrated in FIG. 11, the certainty factor is calculated by “X/(X+Y)”. At this point, X and Y are as follows.

X: Number of indexes corresponding to any of labels 2 to 4 in peak region

Y: Number of indexes corresponding to label 0 in peak area.

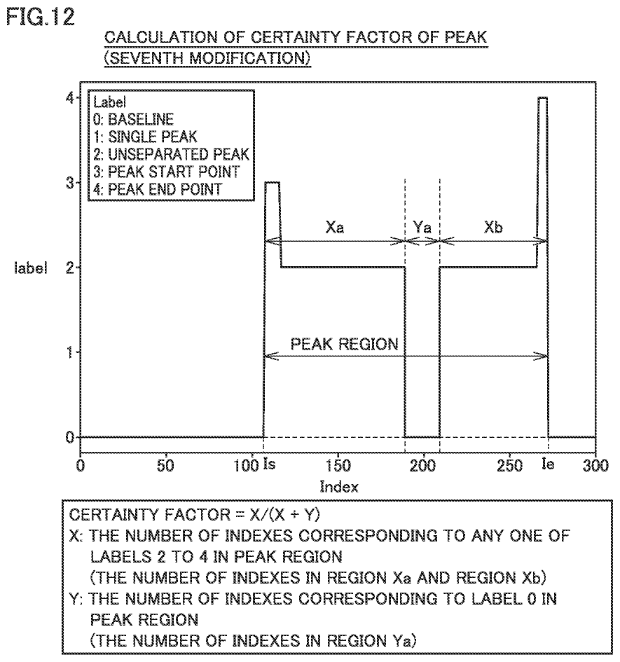

With reference to FIG. 12, the seventh modification will be described in more detail. FIG. 12 is a view illustrating the seventh modification. FIG. 12 is a view in which various regions Xa, Xb, and Ya describing the seventh modification are assigned to a graph obtained by performing the labeling processing on the determination result. In the graph of FIG. 12, the baseline is included in a part of the peak region. The determination result in which the graph in FIG. 12 is drawn may be obtained depending on the relationship between the trained model and the measurement target.

In the calculation formula of the certainty factor of the seventh modification, X is the number of indexes corresponding to any one of labels 2 to 4 in the peak region. This corresponds to the number obtained by adding the number of indexes of region Xa and the number of indexes of region Xb.

In the calculation formula of the certainty factor of the seventh modification, Y is the number of indexes corresponding to label 0 in the peak region. This corresponds to the number of indexes of region Ya.

As described above, analysis device 1 of the embodiment can calculate the certainty factor of the determination result. In particular, analysis device 1 of the embodiment is characterized in that the certainty factor of the determination result is calculated while performing the peak picking using the semantic segmentation technology.

The technique for applying the object detection technology in the field of image recognition and the technique for applying the semantic segmentation technology are known in the peak picking using the deep learning. “Kanazawa S and 10 others, Fake metabolomics chromatogram generation for facilitating deep learning of peak-picking neural networks.J Biosci Bioeng. 2021 February; 131 (2): 207-212. doi: 10.1016/j.jbiosc. 2020.09. 013.Epub 2020 Oct. 10, PMiD: 33051155.” describes that performance is improved by formulating the peak picking problem by the semantic segmentation rather than by the object detection. However, conventionally, there is no technique for calculating the certainty factor in the peak picking in which the semantic segmentation technology is used.

Analysis device 1 of the embodiment can perform the peak picking using the semantic segmentation technology, calculate the certainty factor of the determination result, and display the determination result and the certainty factor on display device 60. Furthermore, analysis device 1 provides an interface that enables the user to correct the determination result. Thus, the user can correct the peak information such as the peak start point and the peak end point detected by the peak picking as needed while simply and efficiently checking the peak information. As a result, according to the embodiment, analysis device 1 capable of outputting the peak detection result with high accuracy can be provided.

The embodiment is merely an example, and can be appropriately changed according to the gist of the present disclosure. Here, the case of processing the waveform of the chromatogram obtained by chromatograph mass spectrometry is described as an example. However, a chromatograph including a detector (spectrophotometer) other than the mass spectrometer and a chromatogram acquired by the gas chromatograph can also be similarly analyzed by analysis device 1. Furthermore, the analysis target is not limited to the chromatogram, For example, a spectroscopic spectrum (the waveform representing the change in detection intensity with respect to the wavelength or a wavenumber axis) acquired by measurement using the spectrophotometer may be analyzed. Any waveform obtained by LC, GC, LC-PDA, LC/MS, GC/MS, LC/MS/MS, GC/MS/MS, LC/MS-IT-TOF, or the like may be analyzed.

### Aspects

It is understood by those skilled in the art that the above-described embodiments and modification thereof are specific examples of the following aspects.

(Item 1) An analysis device according to one aspect is an analysis device that analyzes a target waveform that is a chromatogram or a spectrum, the analysis device including: a processor; and a memory that stores a trained model produced by machine learning using a plurality of sets including a plurality of partial waveforms produced by dividing a reference waveform in which a position of a peak portion is known_{;} wherein the processor divides the target waveform into a plurality of partial waveforms, determines a peak waveform that becomes the peak portion among the plurality of divided partial waveforms using the trained model, and calculates a certainty factor of a determination result of the peak waveform using data output from the trained model when the peak portion of the target waveform is determined using the trained model.

According to the analysis device described in item 1, the certainty factor of the peak picking can be calculated when the peak picking using the semantic segmentation technology is performed.

(Item 2) In the analysis device described in item 1, the processor calculates the certainty factor using a value specified from the data output from the trained model or using data Obtained by performing labeling processing on the data output from the trained model.

According to the analysis device described in item 2, the certainty factor can be appropriately calculated using a value specified from the data output from the trained model or using data obtained by performing labeling processing on the data output from the trained model.

(Item 3) In the analysis device described in item 1, the processor labels the peak waveform to calculate the certainty factor.

According to the analysis device described in item 3, the peak waveform is labeled, and the certainty factor is calculated.

(Item 4) in the analysis device described in item 2 or 3, the label includes at least one of a single peak, an unseparated peak, a peak start point, a peak end point, a peak top, and a baseline.

According to the analysis device described in item 4, at least one label among the single peak, the unseparated peak, the peak start point, the peak end point, the peak top, and the baseline can be used.

(Item 5) in the analysis device described in item 1, the processor calculates an average value of a weight value corresponding to a peak start point of the target waveform and a weight value corresponding to a peak end point of the target waveform as the certainty factor.

According to the analysis device described in item 5, the certainty factor can be calculated by a relatively simple arithmetic expression using the average value of the weight value corresponding to the peak start point of the target waveform and the weight value corresponding to the peak end point of the target waveform.

(Item 6) The analysis device described in any one of items 1 to 5 further includes an output port that outputs a display signal for displaying the determination result and the certainty factor.

According to the analysis device described in item 6, the user can recognize the relationship between the determination result and the certainty factor by inputting the display signal to the display device.

(Item 7) The analysis device described in item 6 further includes a display device that displays the determination result and the certainty factor based on the display signal, in which the processor receives an operation for correcting the determination result when the determination result and the certainty factor are displayed on the display device.

According to the analysis device described in item 7, the user can correct the determination result to a more appropriate result while considering the certainty factor.

(Item 8) An analysis method according to another aspect is an analysis method for analyzing a target waveform that is a chromatogram or a spectrum, the analysis method including: producing a trained model that specifies a peak portion included in an input waveform by machine learning using a plurality of sets of a plurality of partial waveforms produced by dividing a reference waveform in which a position of the peak portion is known; dividing the target waveform into a plurality of partial waveforms; determining a peak waveform that becomes the peak portion among the plurality of divided partial waveforms using the trained model; and calculating a certainty factor of a determination result of the peak waveform using data output from the trained model when the peak portion of the target waveform is determined using the trained model.

According to the analysis method described in item 8, the certainty factor of peak picking can be calculated when the peak picking using the semantic segmentation technology is performed.

The processor may calculate the certainty factor by calculating (second sum+third sum)/(first sum+second sum+third sum), where the sum of the weights of the portions belonging to the peak region in the baseline estimation result is the first sum, the sum of the weights of the portions belonging to the peak region in the single peak estimation result is the second sum, and the sum of the weights of the portions belonging to the peak region in the unseparated peak estimation result is the third sum (sixth modification).

Furthermore, the processor can perform labeling processing on the data output from the trained model, and may calculate the certainty factor by calculating (first total number)/(first total number second total number), where the total number of labels corresponding to any one of the unseparated peak, the peak start point, and the peak end point among the labels belonging to the peak area is set as the first total number and the total number of labels corresponding to the baseline among the labels belonging to the peak area is set as the second total number, (seventh modification).

Although the embodiment of the present invention has been described, it should be considered that the disclosed embodiment is an example in all respects and not restrictive. The scope of the present invention is indicated by the claims, and it is intended that all modifications within the meaning and scope of the claims are included in the present invention.

What is claimed is:

1. An analysis device that analyzes a target waveform that is a chromatogram or a spectrum, the analysis device comprising:
a processor; and
a memory that stores a trained model produced by machine learning using a plurality of sets including a plurality of partial waveforms produced by dividing a reference waveform in which a position of a peak portion is known,
wherein the processor
divides the target waveform into a plurality of partial waveforms,
determines a peak waveform that becomes the peak portion among the plurality of divided partial waveforms using the trained model, and
calculates a certainty factor of a determination result of the peak waveform using data output from the trained model when the peak portion of the target waveform is determined using the trained model.

2. The analysis device according to claim 1, wherein the processor calculates the certainty factor using a value specified from the data output from the trained model or using data obtained by performing labeling processing on the data output from the trained model.

3. The analysis device according to claim 1, wherein the processor labels the peak waveform to calculate the certainty factor.

4. The analysis device according to claim 2, wherein the label includes at least one of a single peak, an unseparated peak, a peak start point, a peak end point, a peak top, and a baseline.

5. The analysis device according to claim 1, wherein the processor calculates an average value of a weight value corresponding to a peak start point of the target waveform and a weight value corresponding to a peak end point of the target waveform as the certainty factor.

6. The analysis device according to claim 1, further comprising an output port that outputs a display signal for displaying the determination result and the certainty factor.

7. The analysis device according to claim 6, further comprising a display device that displays the determination result and the certainty factor based on the display signal,
wherein the processor receives an operation for correcting the determination result when the determination result and the certainty factor are displayed on the display device.

8. An analysis method for analyzing a target waveform that is a chromatogram or a spectrum, the analysis method comprising:
producing a trained model that specifies a peak portion included in an input waveform by machine learning using a plurality of sets of a plurality of partial waveforms produced by dividing a reference waveform in which a position of the peak portion is known;
dividing the target waveform into a plurality of partial waveforms;
determining a peak waveform that becomes the peak portion among the plurality of divided partial waveforms using the trained model; and
calculating a certainty factor of a determination result of the peak waveform using data output from the trained model when the peak portion of the target waveform is determined using the trained model.
